(19) United States
(12) Patent Application Publication
(10) Pub. No.: US 2008/0122570 A1
(43) Pub. Date: May 29, 2008

(54) Power transmission coil

(75) Inventor: Konomu Takaishi, Osaka (JP)

Correspondence Address: BACON & THOMAS, PLLC, 625 SLATERS LANE, FOURTH FLOOR, ALEXANDRIA, VA, 22314, US

(73) Assignee: Aska Electron Co., Ltd., Osaka (JP)

(21) Appl. No.: 11/987,304

(22) Filed: Nov. 29, 2007

(30) Foreign Application Priority Data
Nov. 29, 2006 (JP) 2006-321077

(51) Int. Cl. H01F 27/36

(52) U.S. Cl. 336/84 M

(57) ABSTRACT

A power transmission coil in which heat generation by a magnetic shield itself can be suppressed as far as possible is provided.

A power transmission coil is configured by: a coil (1) wound in a plane; and a magnetic shield member (2) disposed on the rear surface of the coil (1). A most part, e.g. 65% or more, and preferably 70% or more of the area of the surface of the magnetic shield member (2) on which the coil is disposed is covered by the coil (1). In this case, the magnetic shield member (2) is formed in a rectangular shape, and the coil (1) is formed in a rectangular shape similar to the magnetic shield member (2).

### BACKGROUND OF THE INVENTION

1. Field of the Invention

The present invention relates to a power transmission coil which is to be used in a power system for a small portable electronic device such as a portable phone or a PDA, and particularly to a planar coil in which a coil is wound in a planar manner.

2. Description of the Prior Art

In general, a secondary battery is used as a power source in a power system for a small portable electronic device, and a planar coil is used in a charging circuit for the secondary battery (for example, see Patent Reference 1).

[Patent Reference 1] Japanese Patent Application Laying-Open No. 2002-25402

In the prior art, on a precondition that such a coil is mounted, magnetic fluxes from a power transmission coil are absorbed by metal components such as a circuit board attached to the rear surface of the coil and the secondary battery. This causes a problem that heat generation, malfunction, deterioration, and the like occur. In order to solve the problem, it is necessary to use a magnetic shield for blocking and refracting a magnetic flux. However, there still occur heat generation by the coil itself, and heat generation by the shield itself, so that it is difficult to suppress the heat generation as a whole. In this case, the heat generation by the coil itself is obtained as the product of a current and an equivalent series resistance component. The heat generation can be suppressed by improving the wire material and the like, but the heat generation by the magnetic shield itself cannot be suppressed.

As shown in FIG. 2, in a conventional planar coil, a square magnetic shield member (52) is disposed on the rear surface of a coil (51) wound in a circular shape. Therefore, an air gap portion (53) which is not covered by the circular coil (51) is formed in the magnetic shield member (52). Consequently, the magnetic fluxes impinge directly on the magnetic shield member (52), so that the magnetic fluxes are absorbed. As a result, heat generation is caused by a hysteresis loss and an eddy current loss.

The invention has been conducted in view of the above-discussed problem. It is an object of the invention to provide a power transmission coil in which the heat generation by a magnetic shield member itself can be suppressed as far as possible.

### SUMMARY OF THE INVENTION

In order to attain the above-described object, the first invention is characterized in that, in a power transmission coil configured by: a coil wound in a plane; and a magnetic shield member disposed on a rear surface of the coil, a most part of an area of a surface of the magnetic shield member on which the coil is disposed is covered by the coil. In the second invention, the cover ratio by the coil is 65% or more. In the third invention, the cover ratio by the coil is 70% or more. In the fourth invention, the magnetic shield member is formed in a rectangular shape, and the coil is formed in a rectangular shape similar to the magnetic shield member.

### EFFECT OF THE INVENTION

In the invention, the most part of the surface of the magnetic shield member on which the coil is disposed is covered by the coil, and hence the temperature rise as a whole of the coil can be suppressed and the transmission efficiency can be improved.

### BRIEF DESCRIPTION OF THE DRAWINGS

FIG. 1 is a schematic diagram showing an embodiment of the invention; and

FIG. 2 is a schematic diagram showing a conventional power transmission coil.

### DETAILED DESCRIPTION OF THE PREFERRED EMBODIMENT

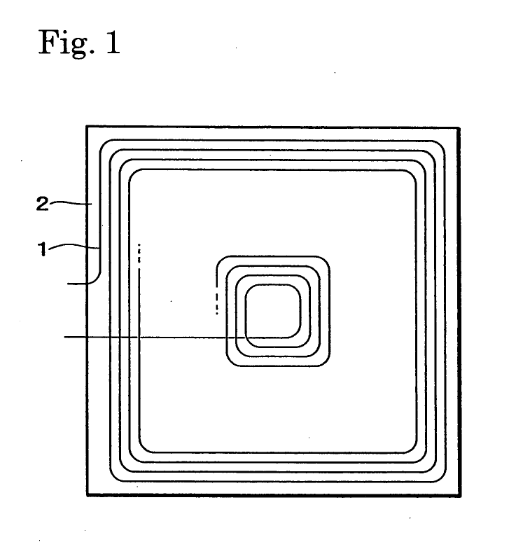

FIG. 1 is a schematic diagram showing an embodiment of the invention. In the embodiment, on a rear surface side of a coil (1) which is wound in a planar and substantially square manner, a square magnetic shield member (2) is disposed.

The coil (1) may be configured by a printed wiring on a laminated printed board, a single-core lead wire which is wound in a square manner, or a litz wire which is wound in a square manner.

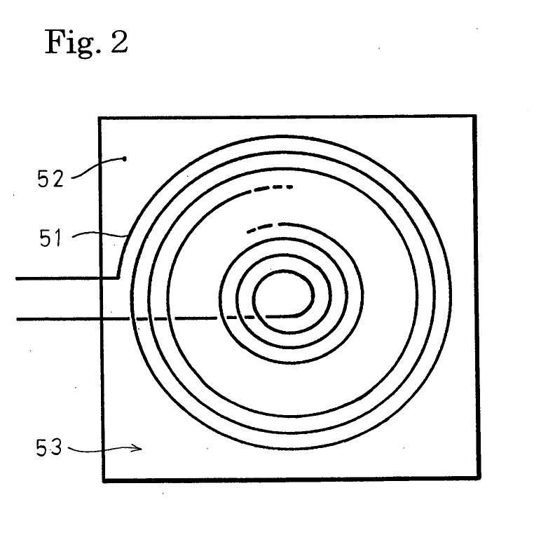

A power transmission coil having a conventional configuration shown in FIG. 2 in which a magnetic shield material of 35 mm square is disposed on the rear surface side of a circular coil wound in a circular manner with a diameter of 30 mm, and a power transmission coil having the configuration of the invention shown in FIG. 1 in which a magnetic shield material of 35 mm square is disposed on the rear surface side of a square coil wound in a square of 30 mm were left to stand until their temperature rises were saturated. In the case of the circular coil, the temperature rise was 15.7° C., and, in the case of the square coil, the temperature rise was 5.9° C.

With respect to the power transfer efficiencies of the above-described two types of coils, the circular coil was 66.5%, and the square coil was 72.4%. This is supposed that the absolute value of a power receiving coil area of the square coil is larger, whereby the efficiency is improved.

In the case where the circular coil with a diameter of 30 mm is magnetically shielded by the magnetic shield material of 35 mm square, the area ratio at which the surface of the magnetic shield material is covered by the coil is 57.7%. By contrast, the area ratio at which the surface of the magnetic shield material of 35 mm square is covered by the square coil wound in a square of 30 mm is 73.4%. Therefore, the temperature rise of the magnetic shield material can be suppressed by covering 60% or more, preferably 70% or more of the surface area of the magnetic shield member by the coil. In addition, the transmission efficiency can be enhanced.

In the above-described embodiment, the magnetic shield material is configured so as to have a square shape. However, the shield material may have a rectangular shape in accordance with the shape of the secondary battery. In such a case, also the shape of the coil may be rectangular.

In addition, the shape of the coil may be determined in accordance with the shape of the magnetic shield member. For example, the shape of the coil may be diamond or polygon, or circle or ellipsoid.

### INDUSTRIAL APPLICABILITY

The invention can be applied to a non-contact power transmission device in a charging circuit for a secondary battery for a power source of a small portable electronic device such as a portable phone, or other electronic circuits.

What is claimed is:

1. A power transmission coil configured by: a coil wound in a plane; and a magnetic shield member disposed on a rear surface of said coil, wherein
a most part of an area of a surface of said magnetic shield member on which said coil is disposed is covered by said coil.

2. A power transmission coil according to claim 1, wherein an area of said magnetic shield member covered by said coil is 65% or more of the area of said surface of said magnetic shield member on which said coil is disposed.

3. A power transmission coil according to claim 1, wherein 70% or more of the area of the surface of said magnetic shield member on which said coil is disposed is covered by said coil wound in a square manner.

4. A power transmission coil according to claim 1, wherein said magnetic shield member is formed in a rectangular shape, and said coil is formed in a rectangular shape similar to said magnetic shield member.

5. A power transmission coil according to claim 2, wherein said magnetic shield member is formed in a rectangular shape, and said coil is formed in a rectangular shape similar to said magnetic shield member.

6. A power transmission coil according to claim 3, wherein said magnetic shield member is formed in a rectangular shape, and said coil is formed in a rectangular shape similar to said magnetic shield member.
